(19) United States
(12) Patent Application Publication
(10) Pub. No.: US 2025/0294523 A1
(43) Pub. Date: Sep. 18, 2025

(54) AUXILIARY RESOURCE SET-BASED COMMUNICATION METHOD AND APPARATUS, AND NON-TRANSITORY COMPUTER-READABLE STORAGE MEDIUM

(71) Applicant: Beijing Xiaomi Mobile Software Co., Ltd., Beijing (CN)

(72) Inventors: Wensu ZHAO, Beijing (CN); Qun ZHAO, Beijing (CN)

(73) Assignee: Beijing Xiaomi Mobile Software Co., Ltd., Beijing (CN)

(21) Appl. No.: 18/857,614

(22) PCT Filed: Apr. 18, 2022
(86) PCT No.: PCT/CN2022/087484

§ 371 Date: Oct. 17, 2024

(51) Int. Cl. H04W 72/02; H04W 72/0446; H04W 72/20; H04W 80/02

(52) U.S. Cl. CPC H04W 72/02; H04W 72/0446; H04W 72/20; H04W 80/02

(57) ABSTRACT

The present disclosure relates to an auxiliary resource set-based communication method and apparatus, and a storage medium. The auxiliary resource set-based communication method is executed by a first user equipment and comprises: determining a window end time domain position of a resource selection window, the resource selection window being a time window for the first user equipment to send an auxiliary resource set to a second user equipment, and the window end time domain position being determined on the basis of a specified time domain position offset; and sending the auxiliary resource set to the second user equipment on the basis of the window end time domain position. The present disclosure can alleviate the situation that auxiliary resources cannot be used because the auxiliary resources are outdated due to the fact that the auxiliary resources indicated by the auxiliary resource set are received after the window end time domain position.

### TECHNICAL FIELD

The present disclosure relates to the field of communication technology, and in particular, to a method and apparatus for communication based on an auxiliary resource set, and a storage medium.

### BACKGROUND

In the enhancement of new radio (NR) Sidelink (SL), with aspect to resource allocation in enhanced Mode 2, the Third Generation Partnership (3GPP) working group reaches a conclusion that a manner of communication based on an auxiliary resource set needs to be studied, which may also be understood as a manner of auxiliary selection of resources between user equipment.

In a manner of auxiliary selection of resources between user equipment, two user equipment may be determined, for example, user equipment A and user equipment B, where the user equipment A is an auxiliary user equipment of the user equipment B. The user equipment B is the user equipment that needs to perform resource selection for its own data transmission. The user equipment A may send an auxiliary resource set to the user equipment B of which the resource selection manner is Mode 2, and the user equipment B may take it into consideration when performing resource selection for its own data transmission.

In the related art, the user equipment A may send the auxiliary resource in the resource selection window for sending the auxiliary resource set, and the auxiliary resource set includes the indicated auxiliary resource. However, in the related art, there is a situation that after the user equipment B receives the auxiliary resource set sent by the user equipment, the auxiliary resource indicated in the auxiliary resource set has been are outdated and cannot be used, and the communication performance is improved.

### SUMMARY

In order to overcome the problem existing in the related art, the present disclosure provides a method and apparatus for communication based on an auxiliary resource set, and a storage medium.

According to a first aspect of the embodiments of the present disclosure, there is provided a method for communication based on an auxiliary resource set, performed by first user equipment, and including:

determining a window end time domain position of a resource selection window, where the resource selection window is a time window for the first user equipment to send an auxiliary resource set to second user equipment, and the window end time domain position is determined based on a specified time domain position offset; and sending the auxiliary resource set to the second user equipment based on the window end time domain position

In an embodiment, the window end time domain position is determined based on a first time domain position and a first time domain position offset; and the first time domain position is determined based on a time domain position corresponding to a resource indicated in the auxiliary resource set, and the first time domain position offset is determined based on a time for the second user equipment to decode the auxiliary resource set.

In an embodiment, the window end time domain position is a time domain position corresponding to the first time domain position being reduced by the first time domain position offset, or the window end time domain position is earlier than the time domain position corresponding to the first time domain position being reduced by the first time domain position offset.

In an embodiment, the first time domain position is a time domain position of a n-th resource in a m-th resource combination indicated in the auxiliary resource set; and a value of n is a positive integer less than or equal to 3; when control information is used to carry the auxiliary resource set, a value of m is a positive integer less than or equal to 2; and when a media access control (MAC) control element (CE) is used to carry the auxiliary resource set, the value of m≤M, and M is determined according to an indication of a network device.

In an embodiment, the value of m is 1, and the value of n is 1.

In an embodiment, the first time domain position is a time domain position of a x-th resource indicated in the auxiliary resource set, and a value of x is a positive integer less than or equal to 6.

In an embodiment, the value of x is 1.

In an embodiment, sending the auxiliary resource set to the second user equipment based on the window end time domain position includes: sending the auxiliary resource set to the second user equipment in the resource selection window.

In an embodiment, the time domain position corresponding to the first time domain position being reduced by the first time domain position offset is earlier than a time domain position corresponding to a second time domain position being added by a first specified time domain offset, and the second time domain position is a time domain position for the first user equipment to determine a sending resource for sending the auxiliary resource set; and the first specified time domain offset is a specified number of time unit value, or the first specified time domain offset is a minimum end time of the resource selection window, or the first specified time domain offset is a PDB value of the auxiliary resource set.

In an embodiment, the specified time domain offset is the minimum end time of the resource selection window;
sending the auxiliary resource set to the second user equipment based on the window end time domain position includes:
sending the auxiliary resource set to the second user equipment based on a randomly selected resource; or abandoning sending the auxiliary resource set to the second user equipment in the resource selection window.

In an embodiment, the window end time domain position is determined based on a second time domain position and a second specified time domain offset.

The second time domain position is a time domain position for the first user equipment to determine a sending resource for sending the auxiliary resource set; and the second specified time domain offset is a minimum end time of the resource selection window, or the second specified time domain offset is a PDB value of the auxiliary resource set.

In an embodiment, the window end time domain position is a time domain position corresponding to the second time domain position being added by the second time domain offset, or the window end time domain position is earlier than the time domain position corresponding to the second time domain position being added by the second time domain offset.

In an embodiment, sending the auxiliary resource set to the second user equipment based on the window end time domain position includes:

in response to a time domain position corresponding to a third time domain position being reduced by a first time domain position offset being earlier than the window end time domain position, sending an auxiliary resource at a time domain position after the second time domain position in the auxiliary resource set, or abandoning sending the auxiliary resource set to the second user equipment in the resource selection window; where the third time domain position is determined based on a time domain position corresponding to a resource indicated in the auxiliary resource set, and the first time domain position offset is determined based on a time for the second user equipment to decode the auxiliary resource set.

In an embodiment, the third time domain position is a time domain position of a n-th resource in a m-th resource combination indicated in the auxiliary resource set; and a value of n is a positive integer less than or equal to 3; when control information is used to carry the auxiliary resource set, a value of m is a positive integer less than or equal to 2; and when a MAC CE is used to carry the auxiliary resource set, the value of m≤M, and M is determined according to an indication of a network device.

In an embodiment, when the control information is used to carry the auxiliary resource set, the value of m is 2; and when the MAC CE is used to carry the auxiliary resource set, the value of m is M, M is determined according to the indication of the network device, and the value of n is 3.

In an embodiment, the third time domain position is a time domain position of a x-th resource indicated in the auxiliary resource set, and a value of x is a positive integer less than or equal to 6.

In an embodiment, the value of x is 6.

According to a second aspect of the embodiments of the present disclosure, there is provided a method for communication based on an auxiliary resource set, performed by second user equipment, and including:

determining a window end time domain position of a resource selection window, where the resource selection window is a time window for first user equipment to send an auxiliary resource set to the second user equipment, and the window end time domain position is determined based on a specified time domain position offset; and receiving, based on the window end time domain position, the auxiliary resource set sent by the first user equipment In an embodiment, the window end time domain position is determined based on a first time domain position and a first time domain position offset.

The first time domain position is determined based on a time domain position corresponding to a resource indicated in the auxiliary resource set, and the first time domain position offset is determined based on a time for the second user equipment to decode the auxiliary resource set. In an embodiment, the window end time domain position is a time domain position corresponding to the first time domain position being reduced by the first time domain position offset, or the window end time domain position is earlier than the time domain position corresponding to the first time domain position being reduced by the first time domain position offset.

In an embodiment, the first time domain position is a time domain position of a n-th resource in a m-th resource combination indicated in the auxiliary resource set; and a value of n is a positive integer less than or equal to 3; when control information is used to carry the auxiliary resource set, a value of m is a positive integer less than or equal to 2; and when a media access control (MAC) control unit (CE) is used to carry the auxiliary resource set, the value of m is less than or equal to M, and M is determined according to an indication of a network device.

In an embodiment, the value of m is 1, and the value of n is 1.

In an embodiment, the first time domain position is a time domain position of a x-th resource indicated in the auxiliary resource set, and a value of x is a positive integer less than or equal to 6.

In an embodiment, the value of x is 1.

In an embodiment, receiving, based on the window end time domain position, the auxiliary resource set sent by the first user equipment includes: receiving, in the resource selection window, the auxiliary resource set sent by the first user equipment.

In an embodiment, the time domain position corresponding to the first time domain position being reduced by the first time domain position offset is earlier than a time domain position corresponding to a second time domain position being added by a first specified time domain offset, and the second time domain position is a time domain position for the first user equipment to determine a sending resource for sending the auxiliary resource set; and the first specified time domain offset is a specified number of time unit value, or the first specified time domain offset is a minimum end time of the resource selection window, or the first specified time domain offset is a PDB value of the auxiliary resource set.

In an embodiment, the specified time domain offset is the minimum end time of the resource selection window.

Receiving, based on the window end time domain position, the auxiliary resource set sent by the first user equipment includes:

receiving, based on a resource randomly selected by the first user equipment, the auxiliary resource set sent by the first user equipment; or abandoning receiving, in the resource selection window, the auxiliary resource set sent by the first user equipment.

In an embodiment, the window end time domain position is determined based on a second time domain position and a second specified time domain offset; the second time domain position is a time domain position for the first user equipment to determine a sending resource for sending the auxiliary resource set; and the second specified time domain offset is a minimum end time of the resource selection window, or the second specified time domain offset is a PDB value of the auxiliary resource set.

In an embodiment, the window end time domain position is a time domain position corresponding to the second time domain position being added by the second time domain offset, or the window end time domain position is earlier than the time domain position corresponding to the second time domain position being added by the second time domain offset.

In an embodiment, receiving, based on the window end time domain position, the auxiliary resource set sent by the first user equipment, includes:

in response to a time domain position corresponding to a third time domain position being reduced by a first time domain position offset being earlier than the window end time domain position, receiving an auxiliary resource at a time domain position after the second time domain position in the auxiliary resource set, or abandoning receiving, in the resource selection window, the auxiliary resource set sent by the first user equipment; where the third time domain position is determined based on a time domain position corresponding to a resource indicated in the auxiliary resource set, and the first time domain position offset is determined based on a time for the second user equipment to decode the auxiliary resource set.

In an embodiment, the third time domain position is a time domain position of a n-th resource in a m-th resource combination indicated in the auxiliary resource set; a value of n is a positive integer less than or equal to 3; when control information is used to carry the auxiliary resource set, a value of m is a positive integer less than or equal to 2; and when a MAC CE is used to carry the auxiliary resource set, the value of m is less than or equal to M, and M is determined according to an indication of a network device.

In an embodiment, when the control information is used to carry the auxiliary resource set, the value of m is 2; and, when the MAC CE is used to carry the auxiliary resource set, the value of m is M, M is determined according to the indication of the network device, and the value of n is 3.

In an embodiment, the third time domain position is a time domain position of a x-th resource indicated in the auxiliary resource set, and a value of x is a positive integer less than or equal to 6.

In an embodiment, the value of x is 6.

According to a third aspect of the embodiments of the present disclosure, there is provided an apparatus for communication based on an auxiliary resource set, including:

a processing unit, configured to determine a window end time domain position of a resource selection window, where the resource selection window is a time window for first user equipment to send an auxiliary resource set to second user equipment, and the window end time domain position is determined based on a specified time domain position offset; and a sending unit, configured to send the auxiliary resource set to the second user equipment based on the window end time domain position.

In an embodiment, the window end time domain position is determined based on a first time domain position and a first time domain position offset; and the first time domain position is determined based on a time domain position corresponding to a resource indicated in the auxiliary resource set, and the first time domain position offset is determined based on a time for the second user equipment to decode the auxiliary resource set.

In an embodiment, the window end time domain position is a time domain position corresponding to the first time domain position being reduced by the first time domain position offset, or the window end time domain position is earlier than the time domain position corresponding to the first time domain position being reduced by the first time domain position offset.

In an embodiment, the first time domain position is a time domain position of a n-th resource in a m-th resource combination indicated in the auxiliary resource set; a value of n is a positive integer less than or equal to 3; when control information is used to carry the auxiliary resource set, a value of m is a positive integer less than or equal to 2; and when a media access control (MAC) control element (CE) is used to carry the auxiliary resource set, the value of m is less than or equal to M, and M is determined according to an indication of a network device.

In an embodiment, the value of m is 1, and the value of n is 1.

In an embodiment, the first time domain position is a time domain position of a x-th resource indicated in the auxiliary resource set, and a value of x is a positive integer less than or equal to 6.

In an embodiment, the value of x is 1.

In an embodiment, the sending unit is configured to send the auxiliary resource set to the second user equipment in the resource selection window.

In an embodiment, the time domain position corresponding to the first time domain position being reduced by the first time domain position offset is earlier than a time domain position corresponding to a second time domain position being added by a first specified time domain offset, and the second time domain position is a time domain position for the first user equipment to determine a sending resource for sending the auxiliary resource set; and the first specified time domain offset is a specified number of time unit value, or the first specified time domain offset is a minimum end time of the resource selection window, or the first specified time domain offset is a PDB value of the auxiliary resource set.

In an embodiment, the specified time domain offset is the minimum end time of the resource selection window.

The sending unit is configured to send the auxiliary resource set to the second user equipment based on a randomly selected resource; or abandon sending the auxiliary resource set to the second user equipment in the resource selection window.

In an embodiment, the window end time domain position is determined based on a second time domain position and a second specified time domain offset.

The second time domain position is a time domain position for the first user equipment to determine a sending resource for sending the auxiliary resource set; and the second specified time domain offset is a minimum end time of the resource selection window, or the second specified time domain offset is a PDB value of the auxiliary resource set.

In an embodiment, the window end time domain position is a time domain position corresponding to the second time domain position being added by the second time domain offset, or the window end time domain position is earlier than the time domain position corresponding to the second time domain position being added by the second time domain offset.

In an embodiment, the sending unit is configured to: in response to a time domain position corresponding to a third time domain position being reduced by a first time domain position offset being earlier than the window end time domain position, send an auxiliary resource at a time domain position after the second time domain position in the auxiliary resource set, or abandon sending the auxiliary resource set to the second user equipment in the resource selection window; where the third time domain position is determined based on a time domain position corresponding to a resource indicated in the auxiliary resource set, and the first time domain position offset is determined based on a time for the second user equipment to decode the auxiliary resource set.

In an embodiment, the third time domain position is a time domain position of a n-th resource in a m-th resource combination indicated in the auxiliary resource set; and a value of n is a positive integer less than or equal to 3; when control information is used to carry the auxiliary resource set, a value of m is a positive integer less than or equal to 2; and when a MAC CE is used to carry the auxiliary resource set, the value of m is less than or equal to M, and M is determined according to an indication of a network device.

In an embodiment, when the control information is used to carry the auxiliary resource set, the value of m is 2; and when the MAC CE is used to carry the auxiliary resource set, m is M, M is determined according to the indication of the network device, and the value of n is 3.

In an embodiment, the third time domain position is a time domain position of a x-th resource indicated in the auxiliary resource set, and a value of x is a positive integer less than or equal to 6.

In an embodiment, the value of x is 6.

According to a fourth aspect of the embodiments of the present disclosure, there is provided an apparatus for communication based on an auxiliary resource set, including:

a processing unit, configured to determine a window end time domain position of a resource selection window, where the resource selection window is a time window for first user equipment to send an auxiliary resource set to second user equipment, and the window end time domain position is determined based on a specified time domain position offset; and a receiving unit, configured to receive, based on the window end time domain position, the auxiliary resource set sent by the first user equipment.

In an embodiment, the window end time domain position is determined based on a first time domain position and a first time domain position offset.

The first time domain position is determined based on a time domain position corresponding to a resource indicated in the auxiliary resource set, and the first time domain position offset is determined based on a time for the second user equipment to decode the auxiliary resource set. In an embodiment, the window end time domain position is a time domain position corresponding to the first time domain position being reduced by the first time domain position offset, or the window end time domain position is earlier than the time domain position corresponding to the first time domain position being reduced by the first time domain position offset.

In an embodiment, the first time domain position is a time domain position of a n-th resource in a m-th resource combination indicated in the auxiliary resource set; and a value of n is a positive integer less than or equal to 3; when control information is used to carry the auxiliary resource set, a value of m is a positive integer less than or equal to 2; and when a media access control (MAC) control unit (CE) is used to carry the auxiliary resource set, the value of m is less than or equal to M, and M is determined according to an indication of a network device.

In an embodiment, the value of m is 1, and the value of n is 1.

In an embodiment, the first time domain position is a time domain position of a x-th resource indicated in the auxiliary resource set, and a value of x is a positive integer less than or equal to 6.

In an embodiment, the value of x is 1.

In an embodiment, the receiving unit is configured to receive, in the resource selection window, the auxiliary resource set sent by the first user equipment.

In an embodiment, the time domain position corresponding to the first time domain position being reduced by the first time domain position offset is earlier than a time domain position corresponding to a second time domain position being added by a first specified time domain offset, and the second time domain position is a time domain position for the first user equipment to determine a sending resource for sending the auxiliary resource set; and the first specified time domain offset is a specified number of time unit value, or the first specified time domain offset is a minimum end time of the resource selection window, or the first specified time domain offset is a PDB value of the auxiliary resource set.

In an embodiment, the specified time domain offset is the minimum end time of the resource selection window.

The receiving unit is configured to receive, based on a resource randomly selected by the first user equipment, the auxiliary resource set sent by the first user equipment; or abandon receiving, in the resource selection window, the auxiliary resource set sent by the first user equipment. In an embodiment, the window end time domain position is determined based on a second time domain position and a second specified time domain offset; the second time domain position is a time domain position for the first user equipment to determine a sending resource for sending the auxiliary resource set; and the second specified time domain offset is a minimum end time of the resource selection window, or the second specified time domain offset is a PDB value of the auxiliary resource set.

In an embodiment, the window end time domain position is a time domain position corresponding to the second time domain position being added by the second time domain offset, or the window end time domain position is earlier than the time domain position corresponding to the second time domain position being added by the second time domain offset.

In an embodiment, the receiving unit is configured to: in response to a time domain position corresponding to a third time domain position being reduced by a first time domain position offset being earlier than the window end time domain position, receiving an auxiliary resource at a time domain position after the second time domain position in the auxiliary resource set, or abandoning receiving, in the resource selection window, the auxiliary resource set sent by the first user equipment; where the third time domain position is determined based on a time domain position corresponding to a resource indicated in the auxiliary resource set, and the first time domain position offset is determined based on a time for the second user equipment to decode the auxiliary resource set.

In an embodiment, the third time domain position is a time domain position of a n-th resource in a m-th resource combination indicated in the auxiliary resource set; a value of n is a positive integer less than or equal to 3; when control information is used to carry the auxiliary resource set, a value of m is a positive integer less than or equal to 2; and when a MAC CE is used to carry the auxiliary resource set, the value of m is less than or equal to M, and M is determined according to an indication of a network device.

In an embodiment, when the control information is used to carry the auxiliary resource set, the value of m is 2; and, when the MAC CE is used to carry the auxiliary resource set, m is M, M is determined according to the indication of the network device, and the value of n is 3.

In an embodiment, the third time domain position is a time domain position of a x-th resource indicated in the auxiliary resource set, and a value of x is a positive integer less than or equal to 6.

In an embodiment, the value of x is 6.

According to a fifth aspect of the embodiments of the present disclosure, there is provided an apparatus for communication based on an auxiliary resource set, including:
a processor, and a memory configured to store an instruction executable by the processor;
where the processor is configured to perform the method according to the first aspect or any embodiment of the first aspect.

According to a sixth aspect of the embodiments of the present disclosure, there is provided an apparatus for communication based on an auxiliary resource set, including:
a processor, and a memory configured to store an instruction executable by the processor;
where the processor is configured to perform the method according to the second aspect or any embodiment of the second aspect.

According to a seventh aspect of the embodiments of the present disclosure, there is provided a storage medium, where the storage medium stores an instruction, and when the instruction is executed by a processor, the method according to the first aspect or any embodiment of the first aspect is implemented.

According to an eighth aspect of the embodiments of the present disclosure, there is provided a storage medium, where the storage medium stores an instruction, and when the instruction is executed by a processor, the method according to the second aspect or any embodiment of the second aspect is implemented.

The technical solution provided by the embodiments of the present disclosure may include the following beneficial effects. The first user equipment determines the window end time domain position of the resource selection window based on the specified time domain position offset, and sends the auxiliary resource set to the second user equipment based on the window end time domain position, and the second user equipment, based on the window end time domain position, receives the auxiliary resource set sent by the first user equipment, thus improving the situation that the auxiliary resource is outdated and cannot be used due to the fact that the auxiliary resource indicated in the auxiliary resource set is received after the window end the time domain position.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this description, illustrate embodiments consistent with the present disclosure and, together with the description, serve to explain the principles of the present disclosure.

FIG. 1 is a schematic diagram of a wireless communication system shown according to an example embodiment.

FIG. 2 shows a schematic diagram of a time domain position involved in communication based on an auxiliary resource set shown according to an example embodiment of the present disclosure.

FIG. 3 is a flowchart of a method for communication based on an auxiliary resource set shown according to an example embodiment.

FIG. 4 is a flowchart of a method for communication based on an auxiliary resource set shown according to an example embodiment.

FIG. 5 is a flowchart of a method for communication based on an auxiliary resource set shown according to an example embodiment.

FIG. 6 shows a schematic diagram of insufficient window resources due to a resource selection window for sending an auxiliary resource set being too small in an example embodiment of the present disclosure.

FIG. 7 is a flowchart of a method for communication based on an auxiliary resource set shown according to an example embodiment.

FIG. 8 shows a schematic diagram of presence of an outdated resource shown in an example embodiment of the present disclosure.

FIG. 9 is a flowchart of a method for communication based on an auxiliary resource set shown according to an example embodiment.

FIG. 10 is a flowchart of a method for communication based on an auxiliary resource set shown according to an example embodiment.

FIG. 11 is a block diagram of an apparatus for communication based on an auxiliary resource set shown according to an example embodiment.

FIG. 12 is a block diagram of an apparatus for communication based on an auxiliary resource set shown according to an example embodiment.

FIG. 13 is a block diagram of an apparatus for communication based on an auxiliary resource set shown according to an example embodiment.

### DETAILED DESCRIPTION

Example embodiments will now be described more fully, examples of which are illustrated in the accompanying drawings. The following description refers to the accompanying drawings in which the same numbers in different drawings represent the same or similar elements, unless otherwise represented. The implementations described in the following example embodiments do not represent all implementations consistent with the present disclosure.

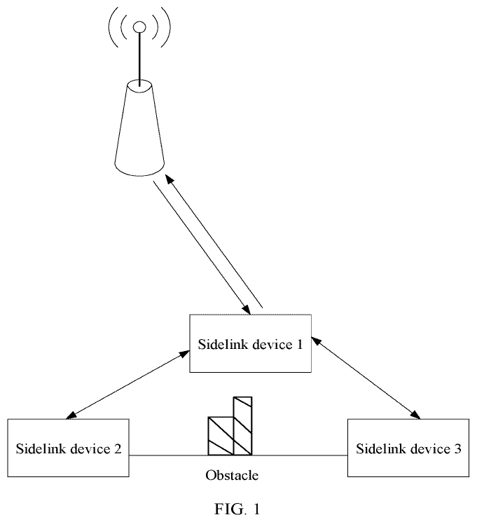

The method for communication based on an auxiliary resource set provided according to the embodiments of the present disclosure may be applied to the Sidelink system shown in FIG. 1.

Referring to FIG. 1, in a scenario that Sidelink is performed between Sidelink devices, the network device configures various transmission parameters for data transmission for the Sidelink device 1. The Sidelink device 1, the Sidelink device 2, and the Sidelink device 3 perform Sidelink. There may be an obstacle between the Sidelink device 2 and the Sidelink device 3. The link for communication between the network device and the Sidelink device is an uplink and a downlink, and the link between a Sidelink device and a Sidelink device is a sidelink.

In the present disclosure, the communication scenario of Sidelink between Sidelink devices may be a service scenario of Vehicle to Everything (V2X), where V represents a vehicle-mounted device, and X represents any object interacting with the vehicle-mounted device. Currently, X mainly includes a vehicle-mounted device, a handheld device, a traffic roadside infrastructure, and a network. The information interaction mode of V2X includes Vehicle to Vehicle (V2V) interaction, Vehicle to Infrastructure (V21) interaction, Vehicle to Pedestrian (V2P) interaction, and Vehicle to Network (V2N) interaction.

With the development of new generation 5G mobile communication technologies, 5G NR technology is used in 3GPP Rel-16 to support new V2X communication services and scenarios, such as vehicle platooning, extended sensors, advanced driving, and remote driving, etc. In general, the 5G V2X Sidelink can provide a higher communication rate, a shorter communication latency, and a more reliable communication quality.

The communication scenario of Sidelink between Sidelink devices may also be a device to device (D2D) communication scenario. The Sidelink device performing Sidelink in the embodiments of the present disclosure may include various handheld devices, vehicle-mounted devices, wearable devices, computing devices with wireless communication functions or other processing devices connected to the wireless modems, and various forms of user equipment (UE), mobile stations (MS), terminals, terminal equipment, or the like. For ease of description, in the embodiments of the present disclosure, description is made below by taking that the Sidelink device is user equipment as an example.

Among them, the enhancement of NR Sidelink may improve transmission reliability and reduce the latency. In the enhancement of NR Sidelink, with aspect to resource allocation in enhanced Mode 2, the 3GPP working group reaches a conclusion that a manner of auxiliary selection of resources between user equipment needs to be studied. In this manner, two user equipment are specified; for example, user equipment A is the auxiliary user equipment of user equipment B, and the user equipment B refers to the user equipment that needs to perform resource selection for data sent by itself. Amon them, the user equipment A may determine a resource set and send the resource set to the user equipment B through Mode 2. When performing resource selection, the user equipment B may take the resource set sent by the user equipment A into consideration. In other words, it may be understood as that the user equipment B performs resource selection by using the auxiliary resource set assistance mechanism, to implement a manner of communication based on the auxiliary resource set. Among them, the user equipment B may send the data to the user equipment A and/or another user equipment. For case of description, in the embodiments of the present disclosure, the user equipment (user equipment A) that provides the auxiliary resource set is referred to as the first user equipment, and the user equipment (user equipment B) that performs resource selection based on the auxiliary resource set is referred to as the second user equipment.

In the related art, in the solution of communication based on an auxiliary resource set, a window start time domain position n′+T′_1 of a resource selection window for the first user equipment to send the auxiliary resource set is defined, and a window end time domain position n′+T′_2 of the resource selection window is defined. Meanwhile, a window start time domain position n+T_1 and a window end time domain position n+T_2 of a resource selection window for the second user equipment to use the auxiliary resource indicated in the auxiliary resource set are defined.

In the solution of communication based on the auxiliary resource set, a manner of auxiliary resource set communication between user equipment based on an auxiliary request is provided, and a manner of auxiliary resource set communication between user equipment based on a condition is also provided. Among them, for the manner of auxiliary resource set communication between the user equipment based on the auxiliary request, (n′+T′_2)≤X2; and for the manner of auxiliary resource set communication based on the condition, (n′+T′_2)<X3, where X2 and X3 are the window end time domain positions of the resource selection window. In the 108b-e conference, it is proposed to study the values of X2 and X3. That is, it is needed to define the window end time domain positions of the resource selection window. Meanwhile, in the related art, it has been approved that the resource sensing window for the second user equipment to determine the auxiliary resource set is [(n+T_1)−T_0−T″_1, (n+T_1)−T_proc,0−T″_1].

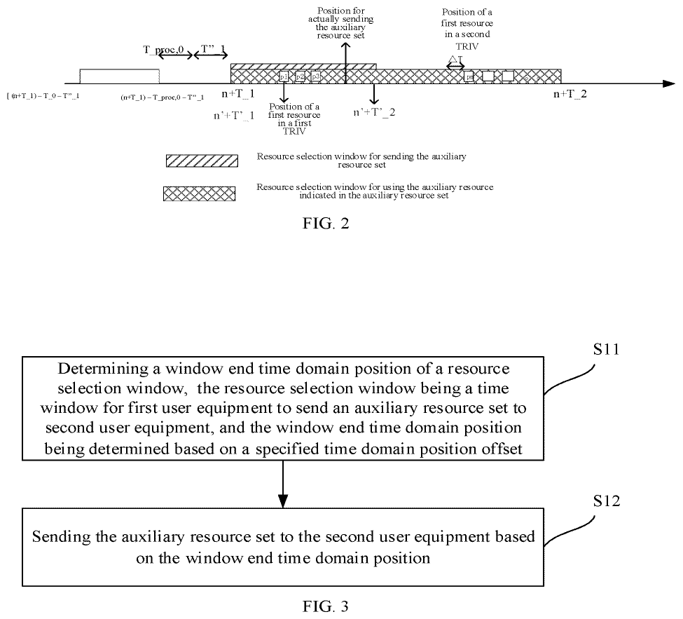

FIG. 2 shows a schematic diagram of a time domain position involved in communication based on an auxiliary resource set shown according to an example embodiment of the present disclosure. Referring to FIG. 2, the resource selection window for the first user equipment to send the auxiliary resource set is [n′+T′_1, n′+T′_2]. The resource selection window for the second user equipment to use the auxiliary resource indicated in the auxiliary resource set is [n+T_1, n+T_2]. The resource sensing window for the second user equipment to determine the auxiliary resource set is [(n+T_1)−T_0−T″_1, (n+T_1)−T_proc,0−T″_1]. Therefore, the difference between the window start time domain position of the resource selection window for the first user equipment to send the of the auxiliary resource set and the window end time domain position of the resource sensing window of the auxiliary resource set is T_proc,0+T″_1, and the difference between the window start time domain position of the resource sensing window for the second user equipment to determine the auxiliary resource set and the window end time domain position of the resource sensing window of the auxiliary resource set is also T_proc,0+T″_1. Therefore, in this manner, it results in that [n′+T′_1, (n′+T′_2)] and [(n+T_1), (n+T_2)] coincide with each other. Thus, there may be a situation that after the second user equipment receives the auxiliary resource set of the first user equipment, the resource set indicated in the auxiliary resource set has been outdated and cannot be used. For example, in FIG. 2, the resource set indicated in the auxiliary resource set of the first user equipment includes the position P1 of a first resource, the position P2 of a second resource, and the position P3 of a third resource in the resource combination. The time domain position for actually the first user equipment to send the auxiliary resource set is after the position P1 of the first resource, the position P2 of the second resource and the position P3 of the third resource in the first resource combination, which results in that when using the auxiliary resources after the second user equipment receives the auxiliary resource set, P1, P2 and P3 in the first resource combination have been outdated and cannot be used. Each resource combination is a resource indication manner combined of a time resource indication (TRIV), a frequency resource indication (FRIV) and a resource reservation periodicity; where a TRIV is a time domain resource indication manner in reuse of R16, indicating time domain positions of n resources in the resource combination; and a FRIV is a frequency domain resource indication manner in reuse of R16, indicating the frequency domain positions of n resources in the resource combination, that is, indicating the sub-channels occupied by the start of the n resources and the number of occupied sub-channels.

Among them, in the embodiments of the present disclosure, n+T1 is the start time domain position of the resource selection window of the second user equipment, or may also be understood as the start time domain position of the resource selection window for the first user equipment to determine the auxiliary resource set. n+T2 is the end time domain position of the resource selection window of the second user equipment, or may also be understood as the start time domain position of the resource selection window for the first user equipment to determine the auxiliary resource set. (n′+T′_1) is the start time domain position of the resource selection window for the first user equipment to send the auxiliary resource set. (n′+T′_2) is the end time domain position of the resource selection window for the first user equipment to send the auxiliary resource set. T″_1 is a time pre-configured by the network device, and is a value specified for Sidelink in reuse of R16. T_proc,0 is a time for processing the sensing result of the user equipment, is a time pre-configured by the network device, and is a value specified for Sidelink in reuse of R16. n′ is a time domain position for the first user equipment to determine the sending resource for the auxiliary resource set at the time domain position n.

With respect to the problem that the resource indicated in the auxiliary resource set is outdated, according to the embodiments of the present disclosure, there is provided a method for communication based on an auxiliary resource set. In the method, the first user equipment determines the window end time domain position of the resource selection window based on a specified time domain position offset, and sends the auxiliary resource set to the second user equipment based on the window end time domain position; and the second user equipment receives, based on the window end time domain position, the auxiliary resource set sent by the first user equipment, thus improving the situation that the auxiliary resource is outdated and cannot be used due to the fact that the auxiliary resource indicated in the auxiliary resource set is received after the window end time domain position.

FIG. 3 is a flowchart of a method for communication based on an auxiliary resource set shown according to an example embodiment. As shown in FIG. 3, the method for communication based on the auxiliary resource set is applied in the first user equipment, and includes the following steps.

In step S11, a window end time domain position of a resource selection window is determined, where the resource selection window is a time window for the first user equipment to send an auxiliary resource set to the second user equipment, and the window end time domain position is determined based on a specified time domain position offset.

In step S12, the auxiliary resource set is sent to the second user equipment based on the window end time domain position.

In the embodiments of the present disclosure, the first user equipment determines the window end time domain position of the resource selection window based on the specified time domain position offset, and sends the auxiliary resource set to the second user equipment based on the window end time domain position, thus improving the situation that the auxiliary resource is outdated and cannot be used due to the fact that the auxiliary resource indicated in the auxiliary resource set is received after the window end time domain position, and improving the communication performance of communication based on the auxiliary resource set.

In the method for communication based on the auxiliary resource set provided by the embodiments of the present disclosure, the window end time domain position of the resource selection window is defined, so as to prevent the auxiliary resource indicated in the auxiliary resource set from being received after the window end time domain position.

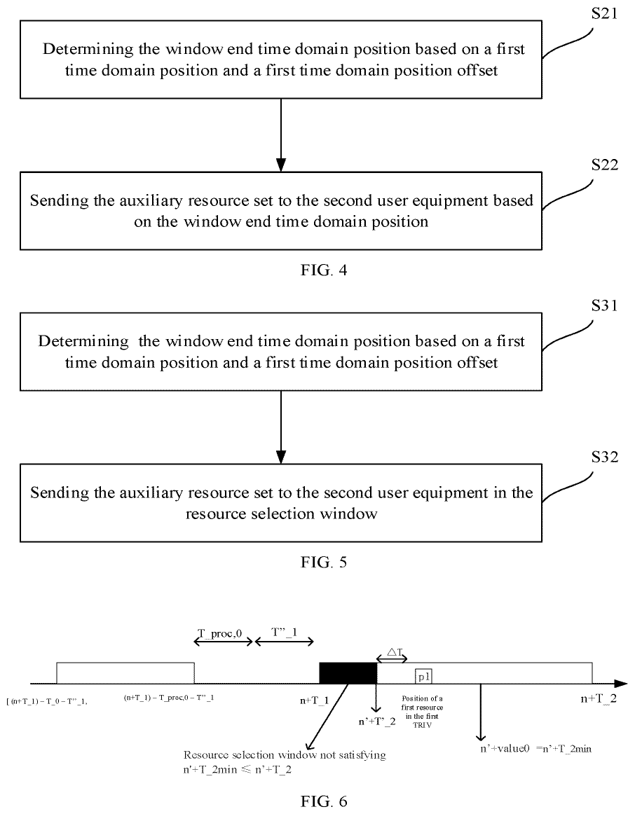

FIG. 4 is a flowchart of a method for communication based on an auxiliary resource set shown according to an example embodiment. As shown in FIG. 4, the method for communication based on the auxiliary resource set is applied in the first user equipment, and includes the following steps.

In step S21, a window end time domain position of a resource selection window is determined based on a first time domain position and a first time domain position offset.

In step S22, an auxiliary resource set is sent to the second user equipment based on the window end time domain position.

Among them, the first time domain position is determined based on a time domain position corresponding to a resource indicated in the auxiliary resource set, and the first time domain position offset is determined based on a time for the second user equipment to decode the auxiliary resource set.

In the following, Pm is used to represent the first time domain position determined based on the time domain position corresponding to the resource indicated in the auxiliary resource set. ΔT is used to represent the first time domain position offset determined according to the time for the second user equipment to decode the auxiliary resource set. n′+T2′ is still used to represent the window end time domain position of the resource selection window for the first user equipment to send the auxiliary resource set.

In the method for communication based on the auxiliary resource set provided by the embodiments of the present disclosure, n′+T2′ is determined based on Pm and ΔT, where Pm is related to the time domain position of the auxiliary resource indicated in the auxiliary resource set, and ΔT may be understood as a time for decoding the auxiliary resource set (IUC, Inter UE Coordination).

In the method for communication based on the auxiliary resource set provided by the embodiments of the present disclosure, n′+T2′ may be a time domain position corresponding to the first time domain position being reduced by the first time domain position offset. That is, n′+T2′=Pm−ΔT.

In the method for communication based on the auxiliary resource set provided by the embodiments of the present disclosure, n′+T2′ may be earlier than the time domain position corresponding to the first time domain position being reduced by the first time domain position offset. That is, n′+T2′<Pm−ΔT.

In the method for communication based on the auxiliary resource set provided by the embodiments of the present disclosure, Pm based on the time domain position corresponding to the resource indicated in the auxiliary resource set, on one hand, may be based on a time domain position of the auxiliary resource indicated in a resource combination, on the other hand, may also be a time domain position of the auxiliary resource set directly indicated in the auxiliary resource set.

In the embodiments of the present disclosure, there are at most two resource combinations, and there are at most three resources indicated in each resource combination.

In an embodiment, in the method for communication based on the auxiliary resource set provided by the embodiments of the present disclosure, Pm is a time domain position of the n-th resource in the m-th resource combination indicated in the auxiliary resource set, where the value of n is a positive integer less than or equal to 3. When the control information is used to carry the auxiliary resource set, the value of m is a positive integer less than or equal to 2, and when the medium access control (MAC) control element (CE) is used to carry the auxiliary resource set, the value of m≤M, and M is determined according to the indication of the network device.

In the method for communication based on the auxiliary resource set provided by the embodiments of the present disclosure, in order to reduce the probability that the auxiliary resource indicated in the auxiliary resource set is received after the window end time domain position, Pm is the time domain position of the resource in the first resource combination indicated in the auxiliary resource set. That is, the value of m is 1.

In the method for communication based on the auxiliary resource set provided by the embodiments of the present disclosure, in order to reduce the probability that the auxiliary resource indicated in the auxiliary resource set is received after the window end time domain position, Pm is the time domain position of the first resource in the resource combination indicated in the auxiliary resource set. That is, the value of n is 1.

In the method for communication based on the auxiliary resource set provided by the embodiments of the present disclosure, in order to reduce the probability that the auxiliary resource indicated in the auxiliary resource set is received after the window end time domain position, Pm is the time domain position of the first resource in the first resource combination indicated in the auxiliary resource set. That is, the value of m is 1, and the value of n is 1.

In the method for communication based on the auxiliary resource set provided by the embodiments of the present disclosure, Pm based on the time domain position corresponding to the resource indicated in the auxiliary resource set may be a time domain position of the auxiliary resource set directly indicated in the auxiliary resource set. For example, Pm is a time domain position of the x-th resource indicated in the auxiliary resource set, and the value of x is a positive integer less than or equal to 6.

In an embodiment, in the method for communication based on the auxiliary resource set provided by the embodiments of the present disclosure, in order to reduce the probability that the auxiliary resource indicated in the auxiliary resource set is received after the window end time domain position, Pm is the time domain position of the first resource indicated in the auxiliary resource set. That is, the value of x is 1.

In the method for communication based on the auxiliary resource set provided by the embodiments of the present disclosure, in a case that n′+T2′=Pm−ΔT, or n′+T2′<Pm−ΔT, the first user equipment sends the auxiliary resource set to the second user equipment in the resource selection window.

FIG. 5 is a flowchart of a method for communication based on an auxiliary resource set shown according to an example embodiment. As shown in FIG. 5, the method for communication based on the auxiliary resource set is applied in the first user equipment, and includes the following steps.

In step S31, a window end time domain position of a resource selection window is determined based on a first time domain position and a first time domain position offset.

Among them, n′+T2′=Pm−ΔT, or n′+T2′<Pm−ΔT.

Pm is the time domain position of the n-th resource in the m-th resource combination indicated in the auxiliary resource set. Alternatively, Pm is the time domain position of the x-th resource indicated in the auxiliary resource set.

In step S32, an auxiliary resource set is sent to the second user equipment in the resource selection window.

In the method for communication based on the auxiliary resource set provided by the embodiments of the present disclosure, in a case that n′+T2′=Pm−ΔT, or n′+T2′<Pm−ΔT, the window end position of the resource selection window for sending the auxiliary resource set is before the time domain position where the auxiliary resource indicated in the auxiliary resource set is located, so that when the first user equipment sends the auxiliary resource set to the second user equipment in the resource selection window, the auxiliary resource indicated in the auxiliary resource set may be prevented from being received after the window end time domain position.

In the method for communication based on the auxiliary resource set provided by the embodiments of the present disclosure, if Pm−ΔT<n′+value0, there may be a situation of insufficient window resources due to the fact that the resource selection window for sending the auxiliary resource set is too small. In this case, the first user equipment may send the auxiliary resource set by using the randomly selected resource, or abandon sending the auxiliary resource set to the second user equipment in the current resource selection window. Among them, in the embodiments of the present disclosure, n′ is a second time domain position, and the second time domain position is a time domain position for the first user equipment to determine the sending resource for sending the auxiliary resource set. value0 is the first specified time domain offset, and the first specified time domain offset is a specified number of time unit value. For example, the first specified time domain offset is one slot. Alternatively, the first specified time domain offset is the minimum end time T2min of the resource selection window. Alternatively, the first specified time domain offset is a packet delay budget (PDB) value corresponding to the auxiliary resource set.

In an embodiment, when the specified time domain offset is the minimum end time T2min of the resource selection window, the first user equipment may send the auxiliary resource set to the second user equipment based on the randomly selected resource, or abandon sending the auxiliary resource set to the second user equipment in the resource selection window.

FIG. 6 shows a schematic diagram of insufficient window resources due to a resource selection window for sending an auxiliary resource set being too small in an example embodiment of the present disclosure. In FIG. 6, value0=T2min is taken as an example for description. Referring to FIG. 6, n′+T2′<n′+T_2min, and the resource selection window does not satisfy n′+T_2min≤n′+T_2; that is, the resource selection window for the first user equipment to send the auxiliary resource set is too small, and resources in the window are insufficient. The first user equipment may send the auxiliary resource set to the second user equipment based on the randomly selected resource, or abandon sending the auxiliary resource set to the second user equipment in the resource selection window.

In the method for communication based on the auxiliary resource set provided by the embodiments of the present disclosure, the window end position of the resource selection window for sending the auxiliary resource set is before the time domain position where the auxiliary resource indicated in the auxiliary resource set is located. Therefore, when the first user equipment sends the auxiliary resource set to the second user equipment in the resource selection window, the auxiliary resource indicated in the auxiliary resource set can be prevented from being received after the window end time domain position.

In the method for communication based on the auxiliary resource set provided by the embodiments of the present disclosure, the window end time domain position is determined based on the time domain position for determining the sending resource for sending the auxiliary resource set being added by the specified time domain offset.

In an embodiment, in the method for communication based on the auxiliary resource set provided by the embodiments of the present disclosure, the window end time domain position is determined based on a second time domain position and a second specified time domain offset. Among them, the second time domain position is a time domain position for the first user equipment to determine the sending resource for sending the auxiliary resource set, and is represented by n′. The second specified time domain offset is represented by value1. The second specified time domain offset may be configured by the network device.

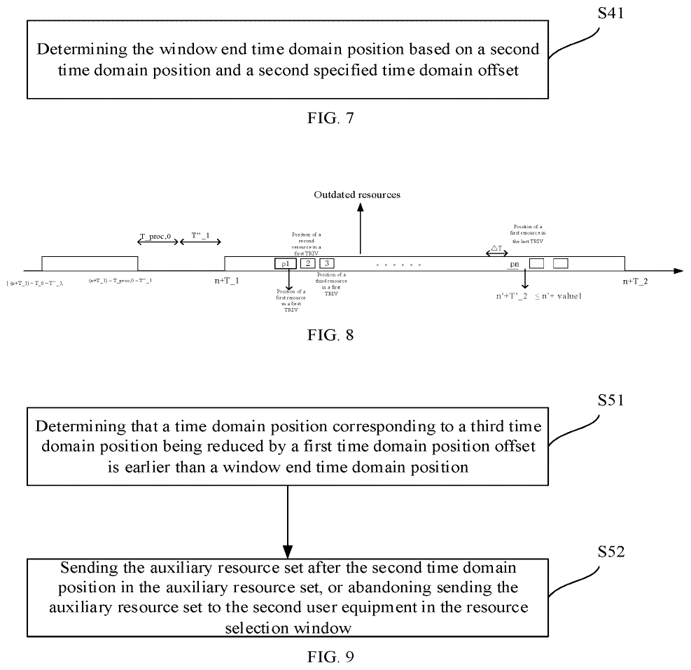

FIG. 7 is a flowchart of a method for communication based on an auxiliary resource set shown according to an example embodiment. As shown in FIG. 7, the method for communication based on the auxiliary resource set is applied in the first user equipment, and includes the following steps.

In step S41, a window end time domain position of a resource selection window is determined based on a second time domain position and a second specified time domain offset.

Among them, the second time domain position is a time domain position for the first user equipment to determine the sending resource for sending the auxiliary resource set, and is represented by n′. The second specified time domain offset is represented by value1, where value1 is the minimum end time of the resource selection window. Alternatively, the second specified time domain offset is the PDB value of the auxiliary resource set.

In the method for communication based on the auxiliary resource set provided by the embodiments of the present disclosure, in an embodiment, the window end time domain position is the time domain position corresponding to the second time domain position added by the second time domain offset. That is, n′+T2′=n′+value1. In another embodiment, the window end time domain position is earlier than the time domain position corresponding to the second time domain position added by the second time domain offset. That is, n′+T2′<n′+value1.

In the method for communication based on the auxiliary resource set provided by the embodiments of the present disclosure, in a case that the window end time domain position is determined based on the second time domain position and the second specified time domain offset, it may result in the situation that the auxiliary resource indicated in the auxiliary resource se is sent before the window end time domain position.

In an example, if the time domain position corresponding to the time domain position corresponding to the resource indicated in the auxiliary resource set being reduced by the time for the second user equipment to decode the auxiliary resource set is earlier than the window end time domain position, it may result in the situation that the auxiliary resource indicated in the auxiliary resource set is sent before the window end time domain position. In a case that the auxiliary resource indicated in the auxiliary resource set is sent before the window end time domain position, there is an outdated resource.

In the embodiments of the present disclosure, for ease of description, a third time domain position is represented by Pn. The time for the second user equipment to decode the auxiliary resource set is still represented by ΔT.

In the embodiments of the present disclosure, in responding to the time domain position corresponding to the third time domain position being reduced by the first time domain position offset being earlier than the window end time domain position, i.e., when Pn−ΔT<n′+T2′, n′+T2′<n′+value1, and there is a problem that resource indicated in the auxiliary resource set is outdated.

FIG. 8 is a schematic diagram of presence of an outdated resource shown in an example embodiment of the present disclosure. In FIG. 8, value0=T2min is taken as an example for description. Referring to FIG. 8, resources indicated in the auxiliary resource set before the time domain position corresponding to n′+T2′<n′+value1, are outdated resources.

In the communication method based on the auxiliary resource set provided by the embodiments of the present disclosure, Pn is related to the time position of the resource indicated in the auxiliary resource set. On one hand, Pn may be based on the time domain position of the auxiliary resource indicated in the resource combination. On the other hand, Pn may be based on the time domain position of the auxiliary resource set directly indicated in the auxiliary resource set.

In the embodiments of the present disclosure, there are at most two resource combinations, and there are at most three resources indicated in each resource combination.

In an embodiment, in the method for communication based on the auxiliary resource set provided by the embodiments of the present disclosure, Pn is the time domain position of the n-th resource in the m-th resource combination indicated in the auxiliary resource set, where the value of n is a positive integer less than or equal to 3. When the control information is used to carry the auxiliary resource set, the value of m is a positive integer less than or equal to 2; and when the MAC CE is used to carry the auxiliary resource set, the value of m≤M, and M is determined according to the indication of the network device.

In the method for communication based on the auxiliary resource set provided by the embodiments of the present disclosure, in a case that Pn is the time domain position of the resource in the second resource combination indicated in the auxiliary resource set, the probability that the auxiliary resource indicated in the auxiliary resource set is sent before the window end time domain position is relatively higher, that is, the probability that there is an outdated resource is relatively higher, and there are many outdated resources. That is, the value of m is 2. When the MAC CE is used to carry the auxiliary resource set, m is M, and M is determined according to the indication of the network device.

In the method for communication based on the auxiliary resource set provided by the embodiments of the present disclosure, Pn is the time domain position of the last resource in the resource combination indicated in the auxiliary resource set. That is, the value of n is 3. The probability that the auxiliary resource indicated in the auxiliary resource set is sent before the window end time domain position is relatively higher, that is, the probability that there is an outdated resource is relatively higher, and there are many outdated resources.

In the method for communication based on the auxiliary resource set provided by the embodiments of the present disclosure, Pn is the time domain position of the third resource in the second resource combination indicated in the auxiliary resource set. That is, the value of m is 2, and the value of m is 3. The probability that the auxiliary resource indicated in the auxiliary resource set is sent before the window end time domain position is relatively higher, that is, the probability that there is an outdated resource is relatively higher, and there are many outdated resources.

In the method for communication based on the auxiliary resource set provided by the embodiments of the present disclosure, Pn based on the time domain position corresponding to the resource indicated in the auxiliary resource set, may be the time domain position of the auxiliary resource set directly indicated in the auxiliary resource set. For example, Pn is the time domain position of the x-th resource indicated in the auxiliary resource set. For example, when the physical layer control signaling is used to carry the auxiliary information, the value of x is a positive integer less than or equal to 6.

In an embodiment, in the method for communication based on the auxiliary resource set provided by the embodiments of the present disclosure, n is the time domain position of the last resource indicated in the auxiliary resource set. That is, the value of x is 6. The probability that the auxiliary resource indicated in the auxiliary resource set is sent before the window end time domain position is relatively higher, that is, the probability that there is an outdated resource is relatively higher, and there are many outdated resources.

In the method for communication based on the auxiliary resource set provided by the embodiments of the present disclosure, in a case that the auxiliary resource indicated in the auxiliary resource set is sent before the window end time domain position, that is, when there is an outdated resource, the first user equipment may exclude the outdated resource and send the auxiliary resource set.

FIG. 9 is a flowchart of a method for communication based on an auxiliary resource set shown according to an example embodiment. As shown in FIG. 9, the method for communication based on the auxiliary resource set is applied in the first user equipment, and includes the following steps.

In step S51, it is determined that a time domain position corresponding to a third time domain position being reduced by a first time domain position offset is earlier than a window end time domain position.

Among them, the third time domain position is determined based on a time domain position corresponding to a resource indicated in the auxiliary resource set, and the first time domain position offset is determined based on a time for the second user equipment to decode the auxiliary resource set.

In an embodiment, the third time domain position is the time domain position of the n-th resource in the m-th resource combination indicated in the auxiliary resource set. The value of n is a positive integer less than or equal to 3. When the control information is used to carry the auxiliary resource set, the value of m is a positive integer less than or equal to 2; and, when the MAC CE is used to carry the auxiliary resource set, the value of m≤M, and M is determined according to the indication of the network device.

In an embodiment, when the control information is used to carry the auxiliary resource set, the value of M is 2. When the MAC CE is used to carry the auxiliary resource set, m is M, and M is determined according to the indication of the network device. The value of n is 3.

In an embodiment, the third time domain position is the time domain position of the x-th resource indicated in the auxiliary resource set. When the control information is used to carry the auxiliary resource set, the value of x is a positive integer less than or equal to 6.

In an embodiment, the value of x is 6.

In step S52, the auxiliary resource set after the second time domain position in the auxiliary resource set is sent, or it is abandoned to send the auxiliary resource set to the second user equipment in the resource selection window.

In the embodiments of the present disclosure, sending the auxiliary resource set after the second time domain position in the auxiliary resource set may be understood as excluding the auxiliary resource at the time domain position before the second time domain position in the auxiliary resource set, and sending the remaining auxiliary resources after the outdated resource is excluded.

In the embodiments of the present disclosure, in a case that the auxiliary resource indicated in the auxiliary resource set is sent before the window end time domain position, that is, when there is an outdated resource, the first user equipment may exclude the outdated resource and send the auxiliary resource set, thus increasing the possibility that the second user equipment normally uses the auxiliary resource, and improving the communication performance of communication based on the auxiliary resource set.

In the method for communication based on the auxiliary resource set provided by the embodiments of the present disclosure, the end time domain position of the resource selection window for sending the auxiliary resource set is determined by specifying the time domain offset (the first time domain offset and the second time domain offset), so that the auxiliary resource set is sent before the window end time domain position, or the outdated auxiliary resource before the window end time domain position is excluded, thus increasing the possibility that the second user equipment normally uses the auxiliary resource, and improving the communication performance of communication based on the auxiliary resource set.

Based on the same concept, according to embodiments of the present disclosure, there is further provided a method for communication based on an auxiliary resource set performed by second user equipment.

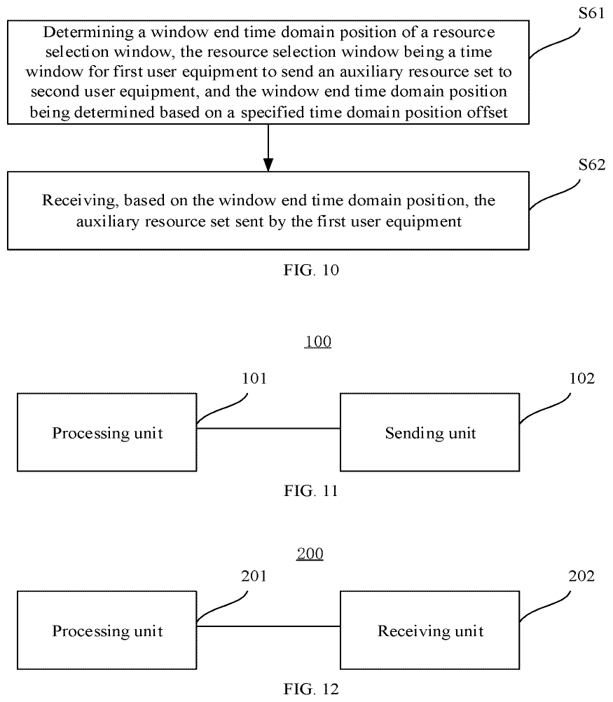

FIG. 10 is a flowchart of a method for communication based on an auxiliary resource set shown according to an example embodiment. As shown in FIG. 10, the method for communication based on the auxiliary resource set is applied in the second user equipment, and includes the following steps.

In step S61, a window end time domain position of a resource selection window is determined, where the resource selection window is a time window for the first user equipment to send an auxiliary resource set to the second user equipment, and the window end time domain position is determined based on a specified time domain position offset.

In step S62, the auxiliary resource set sent by the first user equipment is received based on the window end time domain position.

In the method for communication based on the auxiliary resource set provided by the embodiments of the present disclosure, the second user equipment determines the window end time domain position of the resource selection window based on the specified time domain position offset, and based on the window end time domain position, receives the auxiliary resource set sent by the first user equipment, thus improving the situation that the auxiliary resource is outdated and cannot be used due to the fact that the auxiliary resource indicated in the auxiliary resource set is received after the window end time domain position, and improving the communication performance of communication based on the auxiliary resource set.

In an embodiment, the window end time domain position is determined based on a first time domain position and a first time domain position offset, where the first time domain position is determined based on a time domain position corresponding to a resource indicated in the auxiliary resource set, and the first time domain position offset is determined based on a time for the second user equipment to decode the auxiliary resource set.

In an embodiment, the window end time domain position is the time domain position corresponding to the first time domain position being reduced by the first time domain position offset, that is, n′+T2′=Pm−ΔT. Alternatively, the window end time domain position is earlier than the time domain position corresponding to the first time domain position being reduced by the first time domain position offset, that is, n′+T2′<Pm−ΔT.

In the method for communication based on the auxiliary resource set provided by the embodiments of the present disclosure, the first time domain position based on the time domain position corresponding to the resource indicated in the auxiliary resource set, on one hand, may be based on the time domain position of the auxiliary resource indicated in the resource combination, or on the other hand, may also be the time domain position of the auxiliary resource set directly indicated in the auxiliary resource set.

In the embodiments of the present disclosure, there are at most two resource combinations, and there are at most three resources indicated in each resource combination.

In an embodiment, in the method for communication based on the auxiliary resource set provided by the embodiments of the present disclosure, the first time domain position is the time domain position of the n-th resource in the m-th resource combination indicated in the auxiliary resource set; the value of n is a positive integer less than or equal to 3; when the control information is used to carry the auxiliary resource set, the value of m is a positive integer less than or equal to 2; and when the MAC CE is used to carry the auxiliary resource set, the value of m≤M, and M is determined according to the indication of the network device.

In the method for communication based on the auxiliary resource set provided by the embodiments of the present disclosure, in order to reduce the probability that the auxiliary resource indicated in the auxiliary resource set is received after the window end time domain position, the first time domain position is the time domain position of the resource in the first resource combination indicated in the auxiliary resource set. That is, the value of m is 1.

In the method for communication based on the auxiliary resource set provided by the embodiments of the present disclosure, in order to reduce the probability that the auxiliary resource indicated in the auxiliary resource set is received after the window end time domain position, the first time domain position is the time domain position of the first resource in the resource combination indicated in the auxiliary resource set. That is, the value of n is 1.

In the method for communication based on the auxiliary resource set provided by the embodiments of the present disclosure, in order to reduce the probability that the auxiliary resource indicated in the auxiliary resource set is received after the window end time domain position, the first time domain position is the time domain position of the first resource in the first resource combination indicated in the auxiliary resource set. That is, a value of m is 1, and the value of n is 1.

In the method for communication based on the auxiliary resource set provided by the embodiments of the present disclosure, the first time domain position based on the time domain position corresponding to the resource indicated in the auxiliary resource set, may be the time domain position of the auxiliary resource set directly indicated in the auxiliary resource set. For example, the first time domain position is the time domain position of the x-th resource indicated in the auxiliary resource set. For example, when the physical layer control signaling is used to carry the auxiliary information, the value of x is a positive integer less than or equal to 6.

In an embodiment, in the method for communication based on the auxiliary resource set provided by the embodiments of the present disclosure, in order to reduce the probability that the auxiliary resource indicated in the auxiliary resource set is received after the window end time domain position, the first time domain position is the time domain position of the first resource indicated in the auxiliary resource set. That is, the value of x is 1.

In an embodiment, in the method for communication based on the auxiliary resource set provided by the embodiments of the present disclosure, in a case that n′+T2′=Pm−ΔT or N′+T 2′<Pm−Δt, the second user equipment receives, in the resource selection window, the auxiliary resource set sent by the first user equipment.

In an embodiment, the time domain position corresponding to the first time domain position being reduced by the first time domain position offset is earlier than the time domain position corresponding to the second time domain position being added by the first specified time domain offset, that is, Pm−ΔT<n′+value0. The second time domain position is the time domain position for the first user equipment to determine the sending resource for sending the auxiliary resource set. The first specified time domain offset is a specified number of time unit value, or the first specified time domain offset is the minimum end time of the resource selection window, or the first specified time domain offset is the PDB value of the auxiliary resource set.

In an embodiment, the specified time domain offset is the minimum end time of the resource selection window. The second user equipment receives the auxiliary resource set sent by the first user equipment based on the resource randomly selected by the first user equipment, or abandons receiving the auxiliary resource set sent by the first user equipment in the resource selection window.

In the method for communication based on the auxiliary resource set provided by the embodiments of the present disclosure, the window end position of the resource selection window for sending the auxiliary resource set is before the time domain position of the auxiliary resource indicated in the auxiliary resource set. Therefore, the second user equipment receives the auxiliary resource set sent by the first user equipment in the resource selection window, thus preventing the auxiliary resource indicated in the auxiliary resource set from being received after the window end time domain position.

In the method for communication based on the auxiliary resource set provided by the embodiments of the present disclosure, the window end time domain position is determined based on the time domain position for determining the sending resource for sending the auxiliary resource set being added by the specified time domain offset.

In an embodiment, in the method for communication based on the auxiliary resource set provided by the embodiments of the present disclosure, the window end time domain position is determined based on a second time domain position and a second specified time domain offset. Among them, the second time domain position is a time domain position for the first user equipment to determine the sending resource for sending the auxiliary resource set, and is represented by n′. The second specified time domain offset is represented by value1. The second specified time domain offset may be configured by the network device.

In an embodiment, the second specified time domain offset value1 is the minimum end time of the resource selection window, or the second specified time domain offset value1 is the PDB value of the auxiliary resource set.

In an embodiment, the window end time domain position is the time domain position corresponding to the second time domain position being added by the second time domain offset, or the window end time domain position is earlier than the time domain position corresponding to the second time domain offset being added by the second time domain offset.

In the method for communication based on the auxiliary resource set provided by the embodiments of the present disclosure, in an embodiment, the window end time domain position is the time domain position corresponding to the second time domain position being added by the second time domain offset, that is, n′+T2′=n′+value1. In another embodiment, the window end time domain position is earlier than the time domain position corresponding to the second time domain position being added by the second time domain offset, that is, n′+T2′<n′+value1.

In the method for communication based on the auxiliary resource set provided by the embodiments of the present disclosure, in a case that the window end time domain position is determined based on the second time domain position and the second specified time domain offset, it may result in the situation that the auxiliary resource indicated in the auxiliary resource set is sent before the window end time domain position.

In an embodiment, in responding to the time domain position corresponding to the third time domain position being reduced by the first time domain position offset being earlier than the window end time domain position, i.e., when Pn−ΔT<n′+T2′, n′+T2′<n′+value1, and the second user equipment receives the auxiliary resource set sent by the first user equipment at the time domain position after the second time domain position in the auxiliary resource set, or abandons receiving the auxiliary resource set sent by the first user equipment in the resource selection window.

Among them, the third time domain position Pn is related to the time position of the resource indicated in the auxiliary resource set, and Pn is determined based on a time domain position corresponding to a resource indicated in the auxiliary resource set. On one hand, Pn may be based on a time domain position of an auxiliary resource indicated in a resource combination, or on the other hand, may be a time domain position of an auxiliary resource set directly indicated in the auxiliary resource set.

In the embodiments of the present disclosure, when the control information is used to carry the auxiliary resource set, there are at most two resource combinations, and there are at most three resources indicated in each resource combination. When the MAC CE is used to carry the auxiliary resource set, the value of m≤M, and M is determined according to the indication of the network device.

In an embodiment, in the method for communication based on the auxiliary resource set provided by the embodiments of the present disclosure, Pn is the time domain position of the n-th resource in the m-th resource combination indicated in the auxiliary resource set, where the value of n is a positive integer less than or equal to 3. When the control information is used to carry the auxiliary resource set, the value of m is a positive integer less than or equal to 2; and when the MAC CE is used to carry the auxiliary resource set, the value of m≤M, and M is determined according to the indication of the network device.

In the method for communication based on the auxiliary resource set provided by the embodiments of the present disclosure, in a case that Pn is the time domain position of the resource in the third resource combination indicated in the auxiliary resource set, the probability that the auxiliary resource indicated in the auxiliary resource set is sent before the window end time domain position is relatively higher, that is, the probability that there is an outdated resource is relatively higher, and there are many outdated resources. That is, when the control information is used to carry the auxiliary resource set, the value of m is 2. When the MAC CE is used to carry the auxiliary resource set, m is M, and M is determined according to the indication of the network device.

In the method for communication based on the auxiliary resource set provided by the embodiments of the present disclosure, Pn is the time domain position of the last resource in the resource combination indicated in the auxiliary resource set. That is, the value of n is 3. The probability that the auxiliary resource indicated in the auxiliary resource set is sent before the window end time domain position is relatively higher, that is, the probability that there is an outdated resource is relatively higher, and there are many outdated resources.

In the method for communication based on the auxiliary resource set provided by the embodiments of the present disclosure, when the control information is used to carry the auxiliary resource set, Pn is the time domain position of the third resource in the second resource combination indicated in the auxiliary resource set. That is, the value of m is 2, and the value of m is 3. Alternatively, when the MAC CE is used to carry the auxiliary resource set, m is M, M is determined according to the indication of the network device, and the value of n is 3. The probability that the auxiliary resource indicated in the auxiliary resource set is sent before the window end time domain position is relatively higher, that is, the probability that there is an outdated resource is relatively higher, and there are many outdated resources.

In the method for communication based on the auxiliary resource set provided by the embodiment of the present disclosure, Pn based on the time domain position corresponding to the resource indicated in the auxiliary resource set, may be the time domain position of the auxiliary resource set directly indicated in the auxiliary resource set. For example, when the physical layer control signaling is used to carry the auxiliary information, Pn is the time domain position of the x-th resource indicated in the auxiliary resource set, and the value of x is a positive integer less than or equal to 6.

In an embodiment, in the method for communication based on the auxiliary resource set provided by the embodiments of the present disclosure, n is the time domain position of the last resource indicated in the auxiliary resource set. That is, the value of x is 6. The probability that the auxiliary resource indicated in the auxiliary resource set is sent before the window end time domain position is relatively higher, that is, the probability that there is an outdated resource is relatively higher, and there are many outdated resources.

In the embodiments of the present disclosure, in a case that there are many outdated resources, the second user equipment may exclude the outdated resources. The second user equipment receives the auxiliary resource set sent by the first user equipment at the time domain position after the second time domain position in the auxiliary resource set, or abandons receiving the auxiliary resource set sent by the first user equipment in the resource selection window, thus improving the communication performance of communication based on the auxiliary resource set.

It may be understood that, the method for communication based on the auxiliary resource set performed by the second user equipment provided by the embodiments of the present disclosure is similar to the method for communication based on the auxiliary resource set performed by the first user equipment. Therefore, for the description that is not thorough enough, reference may be made to the related embodiments of the method for communication based on the auxiliary resource set performed the first user equipment.

It may be understood that the method for communication based on the auxiliary resource set provided by the embodiments of the present disclosure is applicable to a scenario of interactive communication between user equipment, and is also applicable to a scenario of interactive communication between user equipment and a network device. The specific implementation process is similar to the foregoing embodiment, and therefore, details are not described herein again.

It should be noted that those skilled in the art may understand that the various embodiments/implementations involved in the embodiments of the present disclosure may be used in conjunction with the foregoing embodiments, or may be used independently. Whether used alone or in conjunction with the foregoing embodiments, the implementation principles of the embodiments are similar. In the embodiments of the present disclosure, some embodiments are described in the implementations of being used together. Of course, those skilled in the art can understand that such examples are not intended to limit the embodiments of the present disclosure.

Based on the same concept, according to embodiments of the present disclosure, there is further provided an apparatus for communication based on an auxiliary resource set.

It may be understood that, in order to implement the foregoing functions, the apparatus for communication based on the auxiliary resource set provided by the embodiments of the present disclosure includes corresponding hardware structures and/or software modules for performing the various functions. In combination of units and algorithm steps of the examples disclosed in the embodiments of the present disclosure, the embodiments of the present disclosure can be implemented in hardware or a combination of hardware and computer software. Whether a function is performed by hardware or hardware driven by computer software depends on particular applications and design constraint conditions of the technical solutions. Those skilled in the art may use different methods to implement the described functions for each particular application, but it should not be considered that the implementation goes beyond the scope of the technical solutions of the embodiments of the present disclosure.

FIG. 11 is a block diagram of an apparatus for communication based on an auxiliary resource set shown according to an example embodiment. Referring to FIG. 11, the apparatus 100 for communication based on an auxiliary resource set may be provided as the first user equipment in the foregoing embodiments, and includes a processing unit 101 and a sending unit 102.

The processing unit 101 is configured to determine a window end time domain position of a resource selection window, where the resource selection window is a time window for the first user equipment to send an auxiliary resource set to the second user equipment, and the window end time domain position is determined based on a specified time domain position offset. The sending unit 102 is configured to send the auxiliary resource set to the second user equipment based on the window end time domain position.

In an embodiment, the window end time domain position is determined based on a first time domain position and a first time domain position offset; the first time domain position is determined based on a time domain position corresponding to a resource indicated in the auxiliary resource set; and the first time domain position offset is determined based on a time for the second user equipment to decode the auxiliary resource set.

In an embodiment, the window end time domain position is a time domain position corresponding to the first time domain position being reduced by the first time domain position offset, or the window end time domain position is earlier than the time domain position corresponding to the first time domain position being reduced by the first time domain position offset.

In an embodiment, the first time domain position is a time domain position of the n-th resource in the m-th resource combination indicated in the auxiliary resource set; the value of n is a positive integer less than or equal to 3; when the control information is used to carry the auxiliary resource set, the value of m is a positive integer less than or equal to 2; and when the MAC CE is used to carry the auxiliary resource set, the value of m & M, and M is determined according to the indication of the network device.

In an embodiment, the value of m is 1, and the value of n is 1.

In an embodiment, the first time domain position is a time domain position of the x-th resource indicated in the auxiliary resource set. For example, when the physical layer control signaling is used to carry the auxiliary information, the value of x is a positive integer less than or equal to 6.

In an embodiment, the value of x is 1.

In an embodiment, the sending unit 102 is configured to send the auxiliary resource set to the second user equipment in the resource selection window.

In an embodiment, the time domain position corresponding to the first time domain position being reduced by the first time domain position offset is earlier than a time domain position corresponding to a second time domain position being added by a first specified time domain offset; the second time domain position is a time domain position for the first user equipment to determine a sending resource for sending the auxiliary resource set; and the first specified time domain offset is a specified number of time unit value, or the first specified time domain offset is a minimum end time of the resource selection window, or the first specified time domain offset is a PDB value of the auxiliary resource set.

In an embodiment, the specified time domain offset is a minimum end time of the resource selection window;

The sending unit 102 is configured to: send the auxiliary resource set to the second user equipment based on a randomly selected resource, or abandon sending the auxiliary resource set to the second user equipment in the resource selection window.

In an embodiment, the window end time domain position is determined based on a second time domain position and a second specified time domain offset.

The second time domain position is a time domain position for the first user equipment to determine a sending resource for sending the auxiliary resource set, the second specified time domain offset is a minimum end time of the resource selection window, or the second specified time domain offset is a PDB value of the auxiliary resource set.

In an embodiment, the window end time domain position is a time domain position corresponding to the second time domain position being added by the second time domain offset, or the window end time domain position is earlier than the time domain position corresponding to the second time domain position being added by the second time domain offset.

In an embodiment, the sending unit 102 is configured to: in response to a time domain position corresponding to a third time domain position being reduced by the first time domain position offset being earlier than the window end time domain position, send an auxiliary resource at a time domain position after the second time domain position in the auxiliary resource set, or abandon sending the auxiliary resource set to the second user equipment in the resource selection window; the third time domain position is determined based on a time domain position corresponding to a resource indicated in the auxiliary resource set; and the first time domain position offset is determined based on a time for the second user equipment to decode the auxiliary resource set.

In an embodiment, the third time domain position is a time domain position of the n-th resource in the m-th resource combination indicated in the auxiliary resource set; a value of n is a positive integer less than or equal to 3; when control information is used to carry the auxiliary resource set, a value of m is a positive integer less than or equal to 2; and when MAC CE is used to carry the auxiliary resource set, the value of m≤M, and M is determined according to an indication of a network device.

In an embodiment, when the control information is used to carry the auxiliary resource set, the value of m is 2; and when the MAC CE is used to carry the auxiliary resource set, m is M, M is determined according to the indication of the network device, and the value of n is 3.

In an embodiment, the third time domain position is a time domain position of a x-th resource indicated in the auxiliary resource set; and where physical layer control signaling is used to carry auxiliary information, a value of x is a positive integer less than or equal to 6.

In an embodiment, the value of x is 6.

FIG. 12 is a block diagram of an apparatus for communication based on an auxiliary resource set shown according to an example embodiment. Referring to FIG. 12, the apparatus 200 for communication based on an auxiliary resource set may be provided as the second user equipment in the foregoing embodiments, and includes a processing unit 201 and a receiving unit 202.

The processing unit 201 is configured to determine a window end time domain position of a resource selection window, where the resource selection window is a time window for the first user equipment to send an auxiliary resource set to the second user equipment, and the window end time domain position is determined based on a specified time domain position offset; and the receiving unit 202 is configured to receive, based on the window end time domain position, the auxiliary resource set sent by the first user equipment.

In an embodiment, the window end time domain position is determined based on a first time domain position and a first time domain position offset.

The first time domain position is determined based on a time domain position corresponding to a resource indicated in the auxiliary resource set, and the first time domain position offset is determined based on a time for the second user equipment to decode the auxiliary resource set.

In an embodiment, the window end time domain position is a time domain position corresponding to the first time domain position being reduced by the first time domain position offset, or the window end time domain position is earlier than the time domain position corresponding to the first time domain position being reduced by the first time domain position offset.

In an embodiment, the first time domain position is a time domain position of a n-th resource in a m-th resource combination indicated in the auxiliary resource set; a value of n is a positive integer less than or equal to 3; when control information is used to carry the auxiliary resource set, a value of m is a positive integer less than or equal to 2; and when a MAC CE is used to carry the auxiliary resource set, the value of m is less than or equal to M, and M is determined according to an indication of a network device.

In an embodiment, the value of m is 1, and the value of n is 1.

In an embodiment, the first time domain position is a time domain position of a x-th resource indicated in the auxiliary resource set. For example, when physical layer control signaling is used to carry auxiliary information, a value of x is a positive integer less than or equal to 6.

In an embodiment, the value of x is 1.

In an embodiment, the receiving unit 202 is configured to receive, in the resource selection window, the auxiliary resource set sent by the first user equipment.

In an embodiment, the time domain position corresponding to the first time domain position being reduced by the first time domain position offset is earlier than a time domain position corresponding to a second time domain position being added by a first specified time domain offset; the second time domain position is a time domain position for the first user equipment to determine a sending resource for sending the auxiliary resource set; the first specified time domain offset is a specified number of time unit value, or the first specified time domain offset is a minimum end time of the resource selection window, or the first specified time domain offset is a PDB value of the auxiliary resource set.

In an embodiment, the specified time domain offset is a minimum end time of the resource selection window.

The receiving unit 202 is configured to: receive, based on a resource randomly selected by the first user equipment, the auxiliary resource set sent by the first user equipment based on the resource randomly selected by the first user equipment; or, abandon receiving, in the resource selection window, the auxiliary resource set sent by the first user equipment.

In an embodiment, the window end time domain position is determined based on a second time domain position and a second specified time domain offset; the second time domain position is a time domain position for the first user equipment to determine a sending resource for sending the auxiliary resource set; and the second specified time domain offset is a minimum end time of the resource selection window, or the second specified time domain offset is a PDB value of the auxiliary resource set.

In an embodiment, the window end time domain position is a time domain position corresponding to the second time domain position being added by the second time domain offset, or the window end time domain position is earlier than the time domain position corresponding to the second time domain position being added by the second time domain offset.

In an embodiment, the receiving unit 202 is configured to: in response to a time domain position corresponding to a third time domain position being reduced by a first time domain position offset being earlier than the window end time domain position, receive an auxiliary resource at a time domain position after the second time domain position in the auxiliary resource set, or abandoning receiving, in the resource selection window, the auxiliary resource set sent by the first user equipment; the third time domain position is determined based on a time domain position corresponding to a resource indicated in the auxiliary resource set, and the first time domain position offset is determined based on a time for the second user equipment to decode the auxiliary resource set.

In an embodiment, the third time domain position is a time domain position of a n-th resource in a m-th resource combination indicated in the auxiliary resource set; a value of n is a positive integer less than or equal to 3; when control information is used to carry the auxiliary resource set, a value of m is a positive integer less than or equal to 2; and when a MAC CE is used to carry the auxiliary resource set, the value of m is less than or equal to M, and M is determined according to an indication of a network device.

In an embodiment, when the control information is used to carry the auxiliary resource set, the value of m is 2. When the MAC CE is used to carry the auxiliary resource set, m is M, M is determined according to the indication of the network device, and the value of n is 3.

In an embodiment, the third time domain position is a time domain position of a x-th resource indicated in the auxiliary resource set. For example, when physical layer control signaling is used to carry auxiliary information, the value of x is a positive integer less than or equal to 6. In an embodiment, the value of x is 6.

With regard to the apparatus in the above embodiments, the specific manner for the various modules to perform operations has been described in detail in the related method embodiments, which will not be described in detail here.

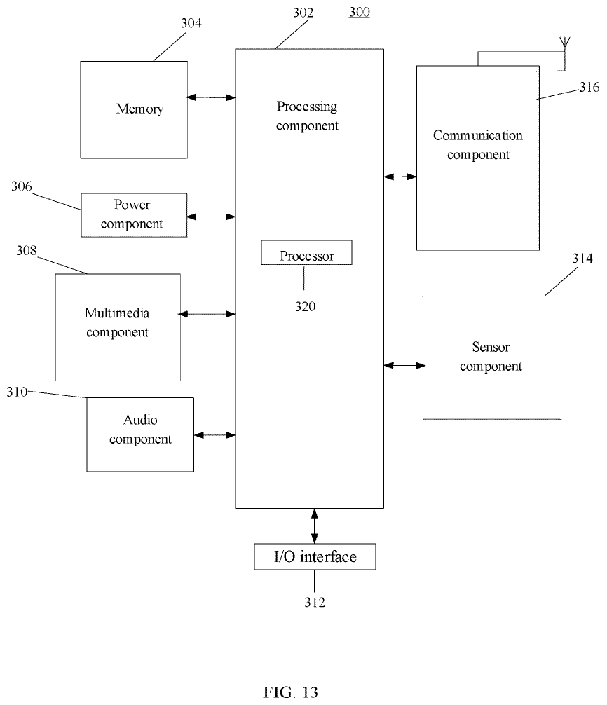

FIG. 13 is a block diagram of an apparatus 300 for communicating based on an auxiliary resource set shown according to an example embodiment. For example, the apparatus 300 may be the first user equipment or the second user equipment involved in the embodiments of the present disclosure. The apparatus 300 may be a mobile phone, a computer, a digital broadcast terminal, a message transmitting and receiving device, a game console, a tablet device, a medical device, an exercise device, a personal digital assistant, or the like.

Referring to FIG. 13, the apparatus 300 may include one or more of the following components: a processing component 302, a memory 304, a power component 306, a multimedia component 308, an audio component 310, an input/output (I/O) interface 312, a sensor component 314, and a communication component 316.

The processing component 302 generally controls overall operations of the apparatus 300, such as operations associated with display, telephone calls, data communications, camera operations, and recording operations. The processing component 302 may include one or more processors 320 to execute instructions to perform all or part of the steps of the above methods. Moreover, the processing component 302 may include one or more modules to facilitate interaction between the processing component 302 and other components. For example, the processing component 302 may include a multimedia module to facilitate interaction between the multimedia component 308 and the processing component 302.

The memory 304 is configured to store various types of data to support the operations of the apparatus 300. Examples of such data include instructions for any application or method that operates on the apparatus 300, contact data, phonebook data, messages, pictures, videos, etc.

The memory 304 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 306 provides power to various components of the apparatus 300. The power component 306 may include a power management system, one or more power sources, and other components associated with generating, managing, and distributing power for the apparatus 300.

The multimedia component 308 includes a screen providing an output interface between the apparatus 300 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touching, sliding, and gestures on the touch panel. The touch sensor may not only sense a boundary of a touching or sliding action, but also detect a duration and pressure associated with the touching or sliding action. In some embodiments, the multimedia component 308 includes a front camera and/or a rear camera. The front camera and/or the rear camera may receive external multimedia data when the apparatus 300 is in an operation mode, such as a photographing mode or a video mode. Each of the front camera and the rear camera may be a fixed optical lens system or have focal length and optical zoom capability.

The audio component 310 is configured to output and/or input audio signals. For example, the audio component 310 includes a microphone (MIC) configured to receive an external audio signal when the apparatus 300 is in an operation mode, such as a call mode, a recording mode, and a voice recognition mode. The received audio signal may be further stored in the memory 304 or transmitted via the communication component 316. In some embodiments, the audio component 310 further includes a speaker configured to output audio signals.

The I/O interface 312 provides an interface between the processing component 302 and a peripheral interface module, which may be a keyboard, a click wheel, a button, or the like. The button may include, but is not limited to, a home button, a volume button, a starting button, and a locking button.

The sensor component 314 includes one or more sensors to provide status assessments of various aspects of the apparatus 300. For example, the sensor component 314 may detect an on/off state of the apparatus 300, and relative positioning of the components, which, for example, may be a display and a keypad of the apparatus 300. The sensor component 314 may also detect the position change of the apparatus 300 or a component of the apparatus 300, the presence or absence of contact by the user with the apparatus 300, the orientation or acceleration/deceleration of the apparatus 300, and the temperature change of the apparatus 300. The sensor component 314 may include a proximity sensor configured to detect the presence of nearby objects without any physical contact. The sensor component 314 may also include a optical sensor, such as a CMOS or CCD image sensor, for use in imaging applications.

In some embodiments, the sensor component 314 may further include an acceleration sensor, a gyroscope sensor, a magnetic sensor, a pressure sensor, or a temperature sensor.

The communication component 316 is configured to facilitate wired or wireless communication between the apparatus 300 and other devices. The apparatus 300 may access a wireless network based on a communication standard, such as WiFi, 2G, or 3G, or a combination of them. In an example embodiment, the communication component 316 receives a broadcast signal or broadcast associated information from an external broadcast management system via a broadcast channel. In an example embodiment, the communication component 316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or other technologies.

In an example embodiment, the apparatus 300 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the methods described above.

In an example embodiment, there is also provided a non-transitory computer-readable storage medium including an instruction, for example, a memory 304 including an instruction, where the instruction may be executed by the processor 320 of the apparatus 300 to complete the above methods. For example, the non-transitory computer-readable storage medium may be a ROM, a random access memory (RAM), a CD-ROM, a magnetic tape, a floppy disk, an optical data storage device, or the like.

It may be further understood that “a plurality of” in the present disclosure refers to two or more, and other quantifiers are similar. “And/or” is used to describe an association relationship between associated objects, indicating that there may be three relationships. For example, A and/or B may indicate that A exists alone, A and B exist at the same time, and B exists alone. The character “/” generally indicates an “or” relationship between the associated objects before and after. The singular forms “a”, “the”, and “said” are intended to include the plural forms as well, unless the context clearly indicates other meanings.

It may be further understood that the terms “first”, “second”, or the like, are used to describe various information, but the information should not be limited to these terms. These terms are only used to distinguish the same type of information from each other and do not represent a specific order or degree of importance. In fact, expressions such as “first” and “second” may be used interchangeably. For example, the first information may also be referred to as second information without departing from the scope of the present disclosure, and similarly, the second information may also be referred to as first information.

It should be further understood that although the operations are described in a specific order in the accompanying drawings, it should not be understood that these operations are required to be performed in the specific order or serial order shown, or all illustrated operations are required to be performed to obtain a desired result. In a specific environment, multitasking and parallel processing may be advantageous.

Other embodiments of the present disclosure will be apparent to those skilled in the art from consideration of the description and practice of the invention disclosed here. The present application is intended to cover any variations, uses, or adaptations of the present disclosure following the general principles of the present disclosure and including common general knowledge and conventional technical means in the art not disclosed in the present disclosure. It should be understood that the present disclosure is not limited to the precise structures that have been described above and shown in the accompanying drawings, and various modifications and changes may be made without departing from the scope of the present disclosure. The scope of the present disclosure is limited only by the appended claims.

What is claimed is:

1. A method for communication based on an auxiliary resource set, performed by first user equipment, and comprising:
determining a window end time domain position of a resource selection window, wherein the resource selection window is a time window for the first user equipment to send an auxiliary resource set to second user equipment, and the window end time domain position is determined based on a specified time domain position offset; and
sending the auxiliary resource set to the second user equipment based on the window end time domain position.

2. The method according to claim 1, wherein the window end time domain position is determined based on a first time domain position and a first time domain position offset; and
the first time domain position is determined based on a time domain position corresponding to a resource indicated in the auxiliary resource set, and the first time domain position offset is determined based on a time for the second user equipment to decode the auxiliary resource set.

3. The method according to claim 2, wherein the window end time domain position is a time domain position corresponding to the first time domain position being reduced by the first time domain position offset, or the window end time domain position is earlier than the time domain position corresponding to the first time domain position being reduced by the first time domain position offset.

4. The method according to claim 2 or 3, wherein the first time domain position is a time domain position of a n-th resource in a m-th resource combination indicated in the auxiliary resource set; and
a value of n is a positive integer less than or equal to 3; when control information is used to carry the auxiliary resource set, a value of m is a positive integer less than or equal to 2; and when a media access control (MAC) control element (CE) is used to carry the auxiliary resource set, the value of m≤M, and M is determined according to an indication of a network device.

5. The method according to claim 4, wherein the value of m is 1, and the value of n is 1.

6. The method according to claim 2 or 3, wherein the first time domain position is a time domain position of a x-th resource indicated in the auxiliary resource set, and a value of x is a positive integer less than or equal to 6.

7. The method according to claim 6, wherein the value of x is 1.

8. The method according to any one of claims 2 to 7, wherein sending the auxiliary resource set to the second user equipment based on the window end time domain position comprises:
sending the auxiliary resource set to the second user equipment in the resource selection window.

9. The method according to any one of claims 3 to 7, wherein the time domain position corresponding to the first time domain position being reduced by the first time domain position offset is earlier than a time domain position corresponding to a second time domain position being added by a first specified time domain offset, and the second time domain position is a time domain position for the first user equipment to determine a sending resource for sending the auxiliary resource set; and
the first specified time domain offset is a specified number of time unit value, or the first specified time domain offset is a minimum end time of the resource selection window, or the first specified time domain offset is a PDB value of the auxiliary resource set.

10. The method according to claim 9, wherein the specified time domain offset is the minimum end time of the resource selection window; and
sending the auxiliary resource set to the second user equipment based on the window end time domain position comprises:
sending the auxiliary resource set to the second user equipment based on a randomly selected resource; or
abandoning sending the auxiliary resource set to the second user equipment in the resource selection window.

11. The method according to claim 1, wherein the window end time domain position is determined based on a second time domain position and a second specified time domain offset;
the second time domain position is a time domain position for the first user equipment to determine a sending resource for sending the auxiliary resource set; and
the second specified time domain offset is a minimum end time of the resource selection window, or the second specified time domain offset is a PDB value of the auxiliary resource set.

12. The method according to claim 11, wherein the window end time domain position is a time domain position corresponding to the second time domain position being added by the second time domain offset, or the window end time domain position is earlier than the time domain position corresponding to the second time domain position being added by the second time domain offset.

13. The method according to claim 11 or 12, wherein sending the auxiliary resource set to the second user equipment based on the window end time domain position comprises:
in response to a time domain position corresponding to a third time domain position being reduced by a first time domain position offset being earlier than the window end time domain position, sending an auxiliary resource at a time domain position after the second time domain position in the auxiliary resource set, or abandoning sending the auxiliary resource set to the second user equipment in the resource selection window;
wherein the third time domain position is determined based on a time domain position corresponding to a resource indicated in the auxiliary resource set, and the first time domain position offset is determined based on a time for the second user equipment to decode the auxiliary resource set.

14. The method according to claim 13, wherein the third time domain position is a time domain position of a n-th resource in a m-th resource combination indicated in the auxiliary resource set; and
a value of n is a positive integer less than or equal to 3; when control information is used to carry the auxiliary resource set, a value of m is a positive integer less than or equal to 2; and when a MAC CE is used to carry the auxiliary resource set, the value of m≤M, and M is determined according to an indication of a network device.

15. The method according to claim 14, wherein when the control information is used to carry the auxiliary resource set, the value of m is 2; and when the MAC CE is used to carry the auxiliary resource set, the value of m is M, M is determined according to the indication of the network device, and the value of n is 3.

16. The method according to claim 13, wherein the third time domain position is a time domain position of a x-th resource indicated in the auxiliary resource set, and a value of x is a positive integer less than or equal to 6.

17. The method according to claim 16, wherein the value of x is 6.

18. A method for communication based on an auxiliary resource set, performed by second user equipment, and comprising:
determining a window end time domain position of a resource selection window, wherein the resource selection window is a time window for first user equipment to send an auxiliary resource set to the second user equipment, and the window end time domain position is determined based on a specified time domain position offset; and
receiving, based on the window end time domain position, the auxiliary resource set sent by the first user equipment.

19. The method according to claim 18, wherein the window end time domain position is determined based on a first time domain position and a first time domain position offset; and
the first time domain position is determined based on a time domain position corresponding to a resource indicated in the auxiliary resource set, and the first time domain position offset is determined based on a time for the second user equipment to decode the auxiliary resource set.

20. The method according to claim 19, wherein the window end time domain position is a time domain position corresponding to the first time domain position being reduced by the first time domain position offset, or the window end time domain position is earlier than the time domain position corresponding to the first time domain position being reduced by the first time domain position offset.

21. The method according to claim 19 or 20, wherein the first time domain position is a time domain position of a n-th resource in a m-th resource combination indicated in the auxiliary resource set; and
a value of n is a positive integer less than or equal to 3; when control information is used to carry the auxiliary resource set, a value of m is a positive integer less than or equal to 2; and when a media access control (MAC) control unit (CE) is used to carry the auxiliary resource set, the value of m is less than or equal to M, and M is determined according to an indication of a network device.

22. The method according to claim 21, wherein the value of m is 1, and the value of n is 1.

23. The method according to claim 19 or 20, wherein the first time domain position is a time domain position of a x-th resource indicated in the auxiliary resource set, and a value of x is a positive integer less than or equal to 6.

24. The method according to claim 23, wherein the value of x is 1.

25. The method according to any one of claims 19 to 24, wherein receiving, based on the window end time domain position, the auxiliary resource set sent by the first user equipment comprises:
receiving, in the resource selection window, the auxiliary resource set sent by the first user equipment.

26. The method according to any one of claims 20 to 24, wherein the time domain position corresponding to the first time domain position being reduced by the first time domain position offset is earlier than a time domain position corresponding to a second time domain position being added by a first specified time domain offset, and the second time domain position is a time domain position for the first user equipment to determine a sending resource for sending the auxiliary resource set; and
the first specified time domain offset is a specified number of time unit value, or the first specified time domain offset is a minimum end time of the resource selection window, or the first specified time domain offset is a PDB value of the auxiliary resource set.

27. The method according to claim 26, wherein the specified time domain offset is the minimum end time of the resource selection window; and
receiving, based on the window end time domain position, the auxiliary resource set sent by the first user equipment comprises:
receiving, based on a resource randomly selected by the first user equipment, the auxiliary resource set sent by the first user equipment; or
abandoning receiving, in the resource selection window, the auxiliary resource set sent by the first user equipment.

28. The method according to claim 18, wherein the window end time domain position is determined based on a second time domain position and a second specified time domain offset;
the second time domain position is a time domain position for the first user equipment to determine a sending resource for sending the auxiliary resource set; and
the second specified time domain offset is a minimum end time of the resource selection window, or the second specified time domain offset is a PDB value of the auxiliary resource set.

29. The method according to claim 28, wherein the window end time domain position is a time domain position corresponding to the second time domain position being added by the second time domain offset, or the window end time domain position is earlier than the time domain position corresponding to the second time domain position being added by the second time domain offset.

30. The method according to claim 28 or 29, wherein receiving, based on the window end time domain position, the auxiliary resource set sent by the first user equipment, comprises:
in response to a time domain position corresponding to a third time domain position being reduced by a first time domain position offset being earlier than the window end time domain position, receiving an auxiliary resource at a time domain position after the second time domain position in the auxiliary resource set, or abandoning receiving, in the resource selection window, the auxiliary resource set sent by the first user equipment;
wherein the third time domain position is determined based on a time domain position corresponding to a resource indicated in the auxiliary resource set, and the first time domain position offset is determined based on a time for the second user equipment to decode the auxiliary resource set.

31. The method according to claim 30, wherein the third time domain position is a time domain position of a n-th resource in a m-th resource combination indicated in the auxiliary resource set; and
a value of n is a positive integer less than or equal to 3; when control information is used to carry the auxiliary resource set, a value of m is a positive integer less than or equal to 2; and when a MAC CE is used to carry the auxiliary resource set, the value of m is less than or equal to M, and M is determined according to an indication of a network device.

32. The method according to claim 31, wherein when the control information is used to carry the auxiliary resource set, the value of m is 2; and, when the MAC CE is used to carry the auxiliary resource set, m is M, M is determined according to the indication of the network device, and the value of n is 3.

33. The method according to claim 30, wherein the third time domain position is a time domain position of a x-th resource indicated in the auxiliary resource set, and a value of x is a positive integer less than or equal to 6.

34. The method according to claim 33, wherein the value of x is 6.

35. An apparatus for communication based on an auxiliary resource set, comprising:
a processing unit, configured to determine a window end time domain position of a resource selection window, wherein the resource selection window is a time window for first user equipment to send an auxiliary resource set to second user equipment, and the window end time domain position is determined based on a specified time domain position offset; and
a sending unit, configured to send the auxiliary resource set to the second user equipment based on the window end time domain position.

36. An apparatus for communication based on an auxiliary resource set, comprising:
a processing unit, configured to determine a window end time domain position of a resource selection window, wherein the resource selection window is a time window for first user equipment to send an auxiliary resource set to second user equipment, and the window end time domain position is determined based on a specified time domain position offset; and
a receiving unit, configured to receive, based on the window end time domain position, the auxiliary resource set sent by the first user equipment.

37. An apparatus for communication based on an auxiliary resource set, comprising:
a processor;
a memory, configured to store an instruction executable by the processor;
wherein the processor is configured to perform the method according to any one of claims 1 to 17 or the method according to any one of claims 18 to 34.

38. A storage medium, wherein an instruction is stored in the storage medium, and when the instruction is executed by a processor, the method according to any one of claims 1 to 17 or the method according to any one of claims 18 to 34 is implemented.
